(19) United States
(12) Patent Application Publication
(10) Pub. No.: US 2008/0033681 A1
(43) Pub. Date: Feb. 7, 2008

(54) User interface system and method

(76) Inventors: Christopher D. Ziomek, Albuquerque, NM (US); Mark Morris, Albuquerque, NM (US); Shawn Knapp-Kleinsorge, Albuquerque, NM (US)

Correspondence Address: V. Gerald Grafe, esq., P.O. Box 2689, Corrales, NM, 87048, US

(21) Appl. No.: 11/500,228

(22) Filed: Aug. 4, 2006

(51) Int. Cl. G06F 19/00

(52) U.S. Cl. 702/108; 702/1; 702/127; 702/187; 702/189

(57) ABSTRACT

The present invention includes an electronic test instrument system, an electronic test instrument, a mobile device and associated methods for testing and interfacing with a system under test. The electronic test instrument system includes an electronic test instrument, a wireless coupler, and a mobile device connectable to the electronic test instrument and adapted to control the electronic test instrument. The mobile device includes a user interface that can by dynamically configurable to permit interfacing with and control of various electronic test instruments in series or substantially simultaneously. The electronic test instrument can be adapted to communicate a set of configurable command controls to the mobile device, such that the identify and control parameters of the electronic test instrument are automatically received by the mobile device.

### BACKGROUND OF THE INVENTION

1. Field of the Invention

The present invention relates generally to the field of electronics, and more particularly to the field of electronic devices, systems and communications.

2. History of the Related Art

There are currently two predominate test and measurement instrument paradigms, traditional and modular. Traditional instruments provide solutions with tightly coupled instrument electronics, data processing, and user interface. Traditional instruments provide all these capabilities within a single self-contained package. The physical size and power requirements of this form factor are often a hindrance, especially in applications where close proximity to device under test or high channel density is desired. Modular instruments provide solutions that de-couple the instrument electronics from the data processing and user interface. Modular instrument solutions depend on a centralized computing environment with complex device and application software to provide data processing and user interface capabilities. The added complexity of this computing and software environment makes modular instruments difficult to use for many manual and interactive applications, primarily limiting their use to computer automated test. There is a need for test and measurement methods and apparatuses that can de-couple the user interface from the instrument electronics and data processing. Such de-coupling can solve the form factor issues associated with traditional instruments and the ease of use issues associated with modular instruments.

### BRIEF DESCRIPTION OF THE FIGURES

FIG. 1 is a schematic block diagram of an electronic test instrument system in accordance with the present invention.

FIG. 2 is a schematic block diagram of an electronic test instrument in accordance with the present invention.

FIG. 3 is a schematic block diagram of a mobile device for controlling an electronic test instrument in accordance with the present invention.

FIG. 4 is a flow chart depicting a method of testing a system under test in accordance with the present invention.

FIG. 5 is a flow chart depicting a method of providing a user interface to a system under test in accordance with the present invention.

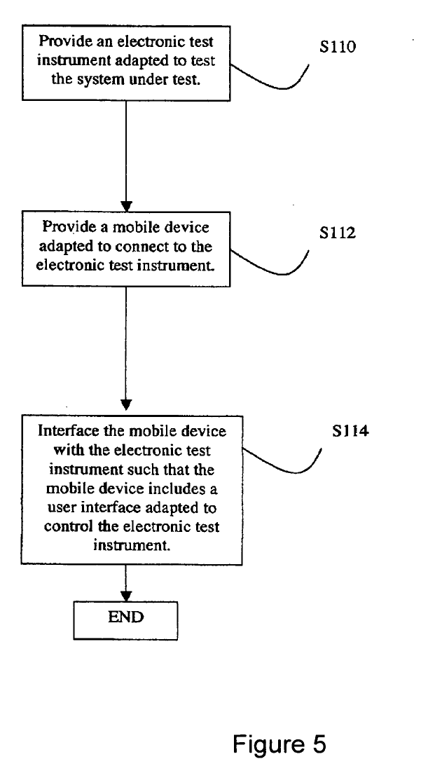

### DETAILED DESCRIPTION OF EXAMPLE EMBODIMENTS

The present invention includes any of: an electronic test instrument system, an electronic test instrument, a mobile device and associated methods for testing and interfacing with a system under test. Although described below with reference to particular example embodiments, the scope of the present invention is nevertheless defined exclusively by the following claims.

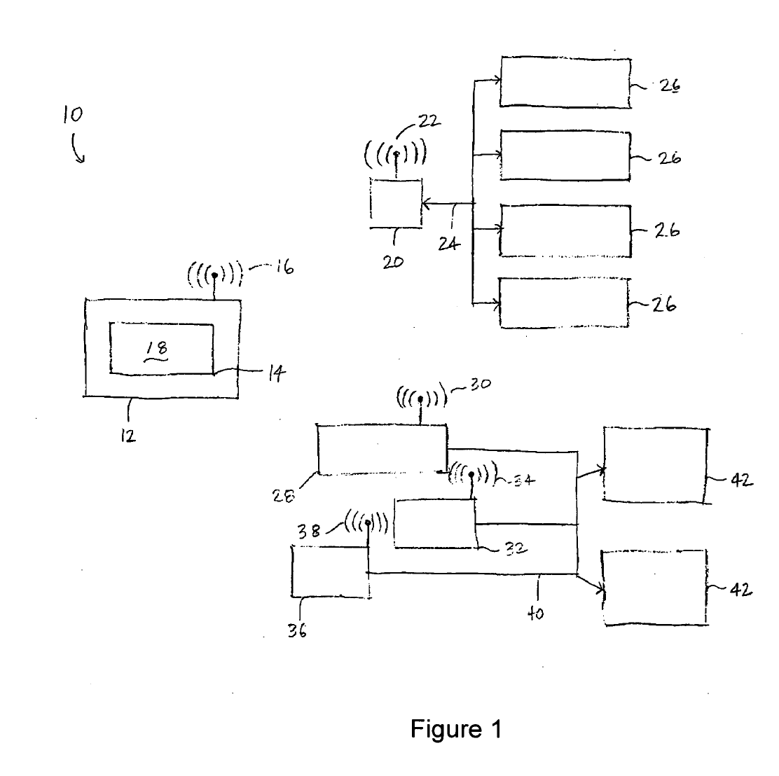

As shown in FIG. 1, an example electronic test instrument system 10 includes an electronic test instrument, a wireless coupler 20 connectable to the electronic test instrument, and a mobile device 12 connectable to the wireless coupler 20 such that the mobile device 12 is communicable with the electronic test instrument. An example mobile device 12 includes a user interface 14 that is adapted to communicate with the electronic test instrument. The wireless coupler 20 can include a coupler antenna 22 that functions to receive and transmit wireless signals. The mobile device 12 can include a device antenna 16 that functions to receive and transmit wireless signals such that the mobile device 12 is connectable with the wireless coupler 20.

The electronic test instrument can include one or more comprehensive or benchtop electronic test instruments 26 of the type known in the art. Example benchtop electronic test instruments 26 include oscilloscopes, spectrum analyzers, network analyzers, logic analyzers, protocol analyzers, millimeters, voltmeters, power meters, power sensors, frequency counters, noise analyzers, LCR meters, resistance meters, impedance analyzers, audio and video analyzers, audio and video generators, dynamic signal analyzers, data loggers, power analyzers, signal generators, function generators, arbitrary waveform generators, pulse pattern generators, AC and DC power supplies, source meters, and the like, all of which typically include a plurality of controls. As shown in FIG. 1, the one or more benchtop electronic test instruments 26 can be connected to the wireless coupler 20 through wired means, such as network cables, coaxial cables or other electrical, optical or optoelectronic wired transmission elements known in the art. Alternatively, the benchtop electronic test instruments 26 can be connected to the wireless coupler 20 through wireless communication means, such as for example radio frequency communications, infrared or any other electrical, optical or optoelectronic wireless communications means known in the art.

Alternatively, the electronic test instrument can include one or more modular electronic test instruments 30 of the type known in the art. Example modular electronic test instruments include oscilloscopes oscilloscopes, spectrum analyzers, network analyzers, logic analyzers, protocol analyzers, millimeters, voltmeters, power meters, power sensors, frequency counters, noise analyzers, LCR meters, resistance meters, impedance analyzers, audio and video analyzers, audio and video generators, dynamic signal analyzers, data loggers, power analyzers, signal generators, function generators, arbitrary waveform generators, pulse pattern generators, AC and DC power supplies, source meters, and the like. As shown in FIG. 1, the one or more modular electronic test instruments 30 can be connected to the wireless coupler 20 through wireless communication means, such as for example radio frequency communications, infrared or any other electrical, optical or optoelectronic wireless communications means known in the art. In this alternative, the one or more modular electronic test instruments 30 can include a modular antenna 32 connected to the modular electronic test instrument 30 and adapted to communicate with the wireless coupler 20. Alternatively, the one or more modular electronic test instruments 30 can be connected to the wireless coupler 20 through wired means, such as for example network cables, coaxial cables or other electrical, optical or optoelectronic wired transmission elements known in the art. As shown in FIG. 1, the modular electronic test instruments 30 can be connected to external devices 42, such as for example desktop or laptop personal computers, servers, external hard drives, or any other such device.

The mobile device 12 functions to communicate with and remotely control the electronic test instrument 26, 30. The mobile device 12 can be any device that is portable with respect to the electronic test instrument 26, 30 and capable of communicating therewith, such as through the wireless coupler 20 described above. The mobile device 12 includes a device antenna 16, described above, which functions to receive and transmit wireless signals. A suitable mobile device 12 can include a laptop computer, a tablet computer, or a mobile display for a personal computer. Alternatively, the mobile device 12 can include any device that functions to communicate with and remotely control the electronic test instrument 26, 30.

A user interface 14 is included in the mobile device 12, and the user interface 14 is adapted to communicate with the electronic test instrument 26, 30. As shown in FIG. 1, the user interface 14 can include a graphical user interface (GUI) 18 which can function as a virtual control panel for the electronic test instrument 26, 30. For example, the GUI 18 can include a series of virtual knobs, virtual controls, and virtual switches in combination with output signals, input signals, and any other type of control associated with the electronic test instrument 26, 30. The user interface 14 includes a touch screen, such that a user can directly interface with the user interface 14 without the need for a keyboard, mouse or any other physical component normally associated with the electronic test instrument 26, 30.

The user interface 14 can be dynamically configurable in nature, and can include a set of configurable command controls that function to control the electronic test instrument 26, 30. The configurable command controls can be selectable based upon the type of electronic test instrument 26, 30 that the user interface 14 is adapted to control. Therefore, as a user interfaces with a first type of electronic test instrument 26, 30, the user interface 14 can provide a first type of configurable command controls. If a user interfaces with a second type of electronic test instrument 26, 30, then the user interface 14 can provide a second type of configurable command controls.

In an alternative embodiment, the configurable command controls can be determined and automatically configured by the electronic test instrument 26, 30, such that the user is not required to input any information regarding the electronic test instrument 26, 30. Rather, the electronic test instrument 26, 30, in communication with the user interface 14, is adapted to direct the user interface 14 to present the user with a predetermined set of configurable command controls in response to the type of electronic test instrument 26, 30. As examples, rotary knobs or sliders can be used to control input and display settings, X-Y graphs or strip charts can be used to display acquired and manipulated data, numeric indicators can be used to display results and configuration settings, switches and buttons can be used to control and display discrete input settings, and LED indicators can be used to display configuration or operation status.

In another alternate embodiment, the mobile device 12 can be adapted to select between two or more electronic test instruments 26, 30. The mobile device 12 therefore permits a user to operate more than one electronic instrument 26, 30 simultaneously on a system under test. As shown in FIG. 1, the mobile device 12 is connectable to a plurality of electronic test instruments 26, 30, each of which can have a different function in testing the system under test. The mobile device 12 thus permits a user to select one of the electronic test instruments 26, 30 and control the latter through the user interface 14 as noted above. In response to a selection of one of the electronic test instruments 26, 30, the user interface 14 will be directed to present the user with a predetermined set of configurable command controls specifically selected by the electronic test instrument 26, 30 to render it controllable by the user.

Alternatively, the mobile device 12 can be adapted to communicate with two or more electronic test instruments 26, 30 substantially simultaneously. The user interface 14 can be configured in such a manner that it provides the user with two or more sets of configurable command controls, one for each electronic test instrument 26, 30. Alternatively, the user interface 14 can be configured in such a manner that it permits a user to readily select between each of the two or more electronic instruments 26, 30, such as for example by providing the user with a set of windows or other selection means known in the art of user interfaces for electronics.

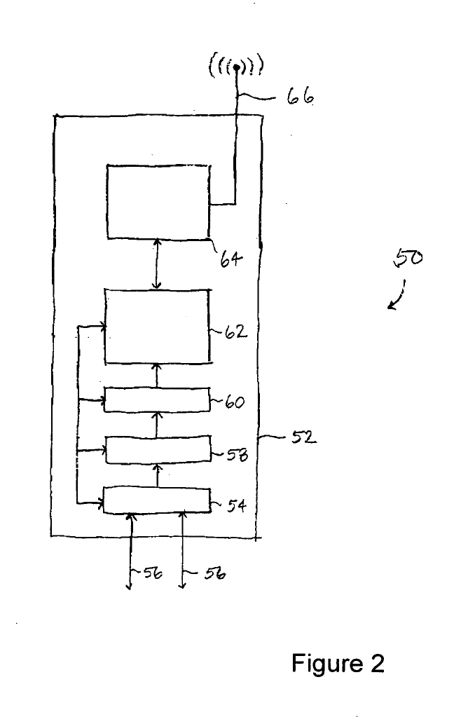

The present invention can also includes an electronic test instrument 50. As shown in FIG. 2, an example electronic test instrument 50 includes signal conditioning circuitry 54, signal conversion circuitry 58 connected to the signal conditioning circuitry 54, signal processing circuitry 60 connected to the signal conversion circuitry 58, and a supervisory and communications controller 62 connected to the signal conditioning circuitry 54, the signal conversion circuitry 58 and the signal processing circuitry 60. The example electronic test instrument 50 also includes an interface system 64 including a wireless interface that is connected to the supervisory and communications controller 62.

The example signal conditioning circuitry 54 can include any suitable signal conditioning circuitry for testing a system under test as currently performed in the art. For example, the signal conditioning circuitry 54 can include elements usable in oscilloscopes, spectrum analyzers, network analyzers, logic analyzers, protocol analyzers, millimeters, voltmeters, power meters, power sensors, frequency counters, noise analyzers, LCR meters, resistance meters, impedance analyzers, audio and video analyzers, audio and video generators, dynamic signal analyzers, data loggers, power analyzers, signal generators, function generators, arbitrary waveform generators, pulse pattern generators, AC and DC power supplies, source meters, and the like. To that end, the signal conditioning circuitry 54 can include one or more connectors 56 that are adapted to be connected to the system under test. The type and configuration of the one or more connectors is dependent upon the type of signal conditioning circuitry 54 used in the electronic test instrument 50. Oscilloscope signal conditioning can include analog and digital signal conditioning such as channel enabling, filtering, coupling, impedance, gain, attenuation, offset and triggering.

Example signal conversion circuitry 58 can include analog to digital converters, digital to analog converters, time to digital converters, digital to time converters, frequency to digital converters, digital to frequency converters.

Example signal processing circuitry 60 can include pre and post acquisition data stream processing, in-line data stream processing. Oscilloscope data processing can include data stream measurements and statistics, calculations, compression, filtering, transformation, conversion, comparison, and event generation.

Example supervisory and communications controller 62 is adapted to control the signal conditioning circuitry 54, the signal conversion circuitry 58, the signal processing circuitry 60, and the interface system 64. The example controller 62 functions to receive, transmit and process electronic, optical or optoelectronic signals from the signal conditioning circuitry 54, the signal conversion circuitry 58, the signal processing circuitry 60, and the interface system 64. The example supervisory and communications controller 62 can also be adapted for instrument control which can include an interface for command and control, data compression, event generation, interface discovery, peripheral discovery, memory management, and configuration management.

The example interface system 64 is adapted to receive and transmit electronic, optical or optoelectronic signals through a wired or wireless connection to the supervisory and communications controller 62. The example interface system 64 includes a wireless interface, which includes a region of space or volume of space within which the interface system 64 can be communicable with an ancillary device (not shown), such as for example a mobile device of the type described above. This is a physical layer for standard or proprietary wireless communications. The wireless protocol is optimized for instrument control applications and to use minimal bandwidth.

In an alternative embodiment, the interface system 64 is adapted to be communicable with a mobile device (not shown) disposable remotely from the electronic test instrument 50. As such, the interface system 64 can include software and hardware usable to transmit and receive wireless signals from a mobile device (not shown) usable in remotely controlling the electronic test instrument 50. For example, the interface system 64 can be connected to an antenna 66 that is adapted to transmit and receive wireless signals, which can be of any electromagnetic variety known in the art, including for example RF signals, IR signals and other types of signals used in the art of communications, as shown in FIG. 2. A suitable mobile device can include can include a laptop computer, a tablet computer, or a mobile display for a personal computer. Alternatively, the mobile device can include any device that functions to communicate with and remotely control the electronic test instrument 50 as described above.

In an alternative embodiment, the interface system 64 is adapted to automatically identify the electronic test instrument 50 to the mobile device in response to the mobile device being within range of the wireless interface.

In an alternative embodiment, the interface system 64 is adapted to determine a display format displayable on the mobile device, which can include a user interface of the type described above. The display format functions to permit a user of the mobile device to remotely interface with the electronic test instrument 50. The user interface of the mobile device can include a GUI of the type known in the art, which can function as a virtual control panel for the electronic test instrument 50. For example, the GUI can include a series of virtual knobs, virtual controls, and virtual switches in combination with output signals, input signals, and any other type of control associated with the electronic test instrument 50. A suitable user interface can include a touch screen, such that a user can directly interface with the user interface without the need for a keyboard, mouse or any other physical component normally associated with the electronic test instrument 50.

In an alternative embodiment, the interface system 64 is adapted to communicate content displayable within the display format on the mobile device. The content of the display format can be dynamically configurable in nature, and can include a set of configurable command controls that function to control the electronic test instrument 50. The configurable command controls are selectable based upon the type of electronic test instrument 50 that the interface system 64 communicates to the mobile device. Therefore, as a user interfaces with a first type of electronic test instrument 50, the interface system 64 can provide a first type of configurable command controls. If a user interfaces with a second type of electronic test instrument 50, then the interface system 64 can provide a second type of configurable command controls.

In other alternative embodiments, the interface system 64 is adapted to compress and/or encrypt data transmittable to the mobile device. The interface system 64 can also be adapted to transmit an identifying set of data to the mobile device such that the identifying set of data identifies the electronic test instrument to the mobile device. As noted above, a suitable mobile device can be adapted to communicate with multiple electronic test instruments 50, including two or more electronic test instruments 50 substantially simultaneously. As such, the interface system can be adapted to include the identifying set of data within a data transmission to the mobile device, such that each communication between any one electronic test instrument 50 and the mobile device identifies that electronic test instrument 50. As with the transmission data, the identifying set of data can be compressed and/or encrypted for transmission. Alternatively, the identifying set of data can be decompressed and/or decrypted during transmission.

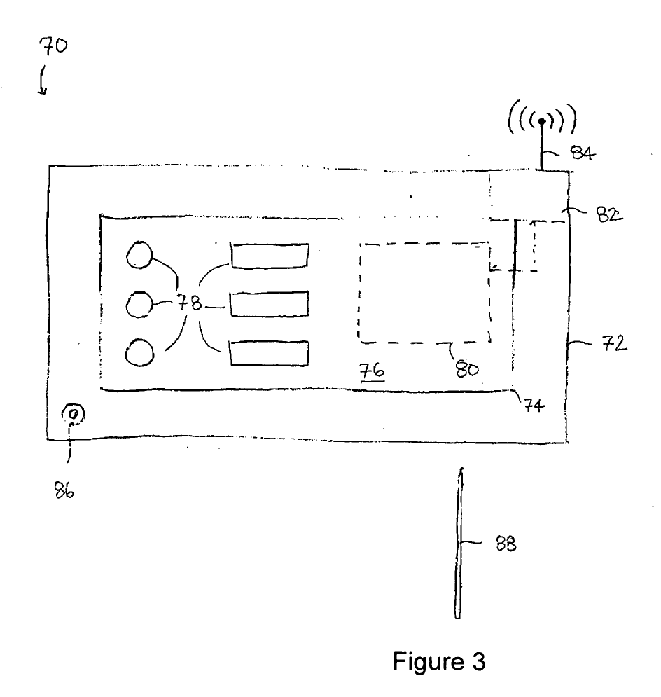

The present invention can further include a mobile device 70 for controlling an electronic test instrument. As shown in FIG. 3, a mobile device includes a wireless interface 82 adapted to connect to the electronic test instrument, a controller 80 connected to the wireless interface, and a user interface 76 connected to the controller. The mobile device 70 functions to permit a user to remotely and directly control the operations, capabilities and functionality of an electronic test instrument. A suitable mobile device 70 can include a laptop computer, a tablet computer, or a mobile display for a personal computer. Alternatively, the mobile device 70 can include any device that functions to communicate with and remotely control the electronic test instrument as described above.

An example wireless interface 82 functions to transmit to and receive communications from a remotely located electronic test instrument. As such, the wireless interface 82 can include software and hardware usable in remotely controlling the electronic test instrument. For example, the wireless interface 82 can be connected to an antenna 84 that is adapted to transmit and receive wireless signals, which can be of any electromagnetic variety known in the art, including for example RF signals, IR signals and other types of signals used in the art of communications. This is a physical layer for standard or proprietary wireless communications. The wireless protocol is optimized for instrument control and to use minimal bandwidth.

An example controller 80 is adapted to control the electronic test instrument through control of the wireless interface system 82 and the user interface 76. The controller 80 functions to receive, transmit and process electronic, optical or optoelectronic signals from the wireless interface system 82 and the user interface. The controller 62 can also be adapted for instrument control which can include an interface for command and control, data compression, event generation, interface discovery, peripheral discovery, and memory management, configuration management.

An example user interface 76 functions to permit a user to interface with a remotely located electronic test instrument and remotely control it there from. The user interface 76 includes a plurality of controls 78 that are adapted to operate the electronic test instrument. In operation, a user's manipulation of the plurality of controls 78 is interpreted by the controller 80 and communicated to the wireless interface 82. The wireless interface 82, as noted above, is adapted to transmit to and receive communications from a remotely located electronic test instrument, including at least communications indicative of a user's operations of the plurality of controls 78. Upon receiving the aforementioned communications, the electronic test instrument, which can be of the type described above with reference to FIGS. 1 and 2, performs the operations and functions requested by the user.

In an alternative embodiment, the user interface 76 is a GUI, which can function as a virtual control panel for the electronic test instrument. For example, the GUI can include the plurality of controls 78, which can include virtual knobs, virtual controls, and virtual switches in combination with output signals, input signals, and any other type of control associated with the electronic test instrument. The alternative user interface 76 can include a touch screen, such that a user can directly interface with the user interface 76 without the need for a keyboard, mouse or any other physical component normally associated with the electronic test instrument.

In an alternative embodiment, the user interface 76 is dynamically configurable in nature, and can include a set of configurable command controls that function to control the electronic test instrument, which include the plurality of controls. The configurable command controls are selectable based upon the type of electronic test instrument that the user interface 76 is adapted to control. Therefore, as a user interfaces with a first type of electronic test instrument, the user interface 76 can provide a first type of configurable command controls. If a user interfaces with a second type of electronic test instrument, then the user interface 76 can provide a second type of configurable command controls.

In an alternative embodiment, the configurable command controls are determined and automatically configured by the electronic test instrument, such that the user is not required to input any information regarding the electronic test instrument. Rather, the electronic test instrument, in communication with the user interface 76, is adapted to direct the user interface 76 to adapt the plurality of controls 78 to present the user with a predetermined set of configurable command controls in response to the type of electronic test instrument. As examples, rotary knobs or sliders can be used to control input and display settings, X-Y graphs or strip charts can be used to display acquired and manipulated data, numeric indicators can be used to display results and configuration settings, switches and buttons can be used to control and display discrete input settings, and LED indicators can be used to display configuration or operation status.

In an alternate embodiment, the mobile device 70 is adapted to select between two or more electronic test instruments. The mobile device 70 thus permits a user to select one of the electronic test instruments and control the latter through the user interface 76 as noted above. In response to a selection of one of the electronic test instruments, the user interface 76 will be directed to present the user with a predetermined set of configurable command controls, such as the plurality of controls 78, specifically selected by the electronic test instrument to render it controllable by the user.

Alternatively, the mobile device 70 can be adapted to communicate with two or more electronic test instruments substantially simultaneously. The user interface 76 can be configured in such a manner that it provides the user with two or more sets of configurable command controls, one for each electronic test instrument. Alternatively, the user interface 76 can be configured in such a manner that it permits a user to readily select between each of the two or more electronic instruments, such as for example by providing the user with a set of windows or other selection means known in the art of user interfaces for electronics.

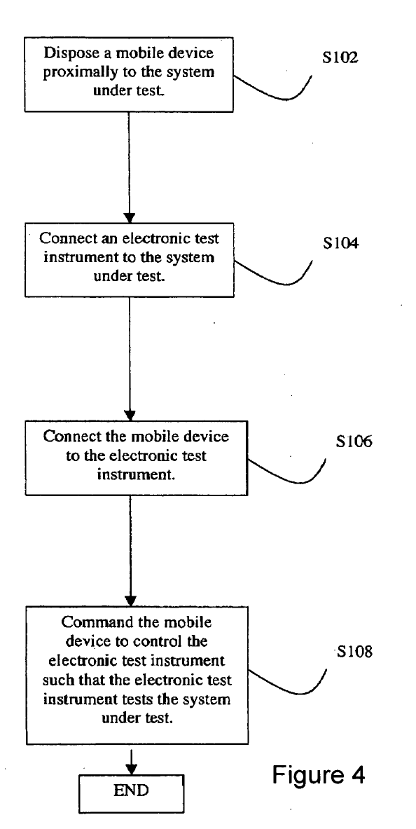

The present invention also includes a method of testing a system under test. Such a method can include a series of steps that can be performed in any order to achieve the equivalent results. For example, as shown in FIG. 4, an example method includes step S102, which recites disposing a mobile device proximally to the system under test. Step S104 recites connecting an electronic test instrument to the system under test, and step S106 recites connecting the mobile device to the electronic test instrument. In step S108, the method recites commanding the mobile device to control the electronic test instrument such that the electronic test instrument tests the system under test. Suitable systems and devices for accomplishing the method as described above include those systems and devices described above with reference to the present invention, although other systems and devices can also be used in the performance of the method.

In an alternative embodiment, the method includes the step of displaying a set of controls for the electronic test instrument on the mobile device. The set of controls can include, for example, a representation of the set of controls for the electronic test instrument. The set of controls can be dynamically configurable in nature, and can include a set of configurable command controls that function to control the electronic test instrument. The set of controls can be selectable based upon the type of electronic test instrument that the method employs. Therefore, as a user interfaces with a first type of electronic test instrument, the method can provide a first type of configurable command controls. If a user interfaces with a second type of electronic test instrument, then the method can provide a second type of configurable command controls.

Alternatively, the set of controls can include a representation of the system under test. The state of the system under test can include for example a representation of the various inputs, outputs, and other parameters relevant to the testing of the system under test. For example, the representation of the state of the system under test can include a graphical representation of an oscilloscope output for an electronic system under test. Example benchtop electronic test instruments include oscilloscopes, spectrum analyzers, network analyzers, logic analyzers, protocol analyzers, millimeters, voltmeters, power meters, power sensors, frequency counters, noise analyzers, LCR meters, resistance meters, impedance analyzers, audio and video analyzers, audio and video generators, dynamic signal analyzers, data loggers, power analyzers, signal generators, function generators, arbitrary waveform generators, pulse pattern generators, AC and DC power supplies, source meters, and the like,. In another alternative, the method can display a representation of the set of controls for the electronic test instrument and a representation of the system under test substantially simultaneously, thus permitting a user to operate and receive feedback from the electronic test instrument substantially simultaneously.

In another alternative, the set of controls can include a representation of a menu of available operations. The menu of available operations can further include various operations employable by a user, such as testing the system under test, selecting an electronic test instrument to perform the testing of the system under test, selecting between two or more systems currently controllable by the mobile device, and the like. Like the set of controls, the menu of available operations can be dynamically configurable in nature, and can include a menu of available operations that function to control the electronic test instrument. The menu of available operations can be selectable based upon the type of electronic test instrument that the method employs. Therefore, as a user interfaces with a first type of electronic test instrument, the method can provide a first menu of available operations. If a user interfaces with a second type of electronic test instrument, then the method can provide a second menu of available operations.

The present invention can also include a method of providing a user interface to a system under test. An example method includes a series of steps that can be performed in any order to achieve the equivalent results. For example, in step S1 0, the method recites providing an electronic test instrument adapted to test the system under test. In step S112, the method recites providing a mobile device adapted to connect to the electronic test instrument, and in step S114 the method recites interfacing the mobile device with the electronic test instrument such that mobile device includes a user interface adapted to control the electronic test instrument. Suitable systems and devices for accomplishing the method as described above include those systems and devices described above with reference to the present invention, although other systems and devices can also be used in the performance of the method.

In an alternative embodiment, the mobile device provided by the method is portable. A suitable mobile device can include a laptop computer, a tablet computer, or a mobile display for a personal computer. Alternatively, the mobile device can include any device that functions to communicate with and remotely control the electronic test instrument. A user interface is included in the mobile device, and the user interface can be adapted to communicate with the electronic test instrument. The user interface can include a GUI of the type known in the art, which can function as a virtual control panel for the electronic test instrument. For example, the GUI can include a series of virtual knobs, virtual controls, and virtual switches in combination with output signals, input signals, and any other type of control associated with the electronic test instrument. The user interface can include a touch screen, such that a user can directly interface with the user interface without the need for a keyboard, mouse or any other physical component normally associated with the electronic test instrument.

In an alternative embodiment, the user interface includes configurable command controls that are configurable in response to an identity of the electronic test instrument. The configurable command controls can be dynamically configurable in nature, such that they are selectable based upon the type of electronic test instrument that the method employs. Alternatively, the configurable command controls can be automatically configured by the electronic test instrument. Therefore, as a user interfaces with a first type of electronic test instrument, the method can provide a first type of configurable command controls. If a user interfaces with a second type of electronic test instrument, then the method can provide a second type of configurable command controls.

In an alternative embodiment, the mobile device is adapted to select between two or more electronic test instruments. The mobile device thus permits a user to select one of the electronic test instruments and control the latter through the user interface as noted above. In response to a selection of one of the electronic test instruments, the user interface can be directed to present the user with a predetermined set of configurable command controls, as described above, specifically selected by the electronic test instrument to render it controllable by the user. Alternatively, the mobile device can be adapted to communicate with two or more electronic test instruments substantially simultaneously. The user interface can be configured in such a manner that it provides the user with two or more sets of configurable command controls, one for each electronic test instrument. Alternatively, the user interface can be configured in such a manner that it permits a user to readily select between each of the two or more electronic instruments, such as for example by providing the user with a set of windows or other selection means known in the art of user interfaces for electronics.

In an alternative embodiment, the method includes the step of connecting the electronic test instrument to a system under test. For example, a user can connect one or more electrical leads to a system under test to measure the electrical properties of the system under test, such as voltage, amperage, inductance, frequency or any other property tested in the art. Additionally, the alternative embodiment can include the step of collecting data from the system under test. The step of data collection can be performed through wired means, or through any other suitable method or means of connecting the electronic test instrument to the system under test and transmitting data there between.

The collected data can be transmitted from the electronic test instrument to the mobile device. In performing this step, the electronic test instrument can be adapted to be communicable with the mobile device disposable remotely from the electronic test instrument. As such, the electronic test instrument and the mobile device can include software and hardware usable to transmit and receive wireless signals there between. For example, the both the electronic test instrument and the mobile device can include an antenna that is adapted to transmit and receive wireless signals, which can be of any electromagnetic variety known in the art, including for example RF signals, IR signals and other types of signals used in the art of communications, as shown in FIGS. 1, 2 and 3.

In still other alternative embodiments, the method includes the steps of compressing and/or encrypting the data collected by the electronic test instrument. The compression and/or encryption of the data collected by the electronic test instrument can be performed before, after, or substantially simultaneously with any transmission of the data to the mobile device. The electronic test instrument can also be adapted to transmit an identifying set of data to the mobile device such that the identifying set of data identifies the electronic test instrument to the mobile device. As noted above, a suitable mobile device can be adapted to communicate with multiple electronic test instruments, including two or more electronic test instruments substantially simultaneously. As such, the interface system can be adapted to include the identifying set of data within a data transmission to the mobile device, such that each communication between any one electronic test instrument and the mobile device identifies that electronic test instrument. As with the data collected by the electronic test instrument, the identifying set of data can be compressed and/or encrypted for transmission. Alternatively, the identifying set of data can be decompressed and/or decrypted during transmission.

Although described herein with reference to its preferred embodiments, it should be understood that various permutations and deviations from the present invention could be readily devised by those skilled in the art of electronics and telecommunications. As such, the scope of the present invention, as defined in the following claims, should be understood to wholly include those permutations and deviations without limitation.

We claim:

1. An electronic test instrument system comprising:
an electronic test instrument;
a wireless coupler connectable to the electronic test instrument;
a mobile device connectable to the wireless coupler such that the mobile device is communicable with the electronic test instrument, the portable device including a user interface adapted to communicate with the electronic test instrument.

2. The system of claim 1 wherein the electronic test instrument includes a plurality of controls.

3. The system of claim 1 wherein the electronic test instrument is connectable to the wireless coupler through wireless means.

4. The system of claim 1 wherein the user interface includes a graphical user interface.

5. The system of claim 1 wherein the user interface includes configurable command modes, the configurable command modes configurable in response to an identity of the electronic test instrument.

6. The system of claim 5 wherein the configurable command controls are automatically configured by the electronic test instrument.

7. The system of claim 1 wherein the user interface includes a touch screen user interface.

8. The system of claim 1 wherein the mobile device is adapted to select between two or more electronic test instruments.

9. The system of claim 8 wherein the mobile device is adapted to communicate with two or more electronic test instruments substantially simultaneously.

10. An electronic test instrument comprising:
an electronic testing unit;
data acquisition circuitry connected to the electronic testing unit;
signal processing circuitry connected to the data acquisition circuitry;
a controller connected to the electronic testing unit, the data acquisition circuitry, and the signal processing circuitry; and
an interface system including a wireless interface, the interface system connected to the controller and adapted to communicate therewith.

11. The instrument of claim 10 wherein the interface system is adapted to be communicable with a mobile device disposable remotely from the electronic test instrument.

12. The instrument of claim 11 wherein the interface system is adapted to automatically identify the electronic test instrument to the mobile device in response to the mobile device being within range of the wireless interface.

13. The instrument of claim 11 wherein the interface system is adapted to determine a display format displayable on the mobile device.

14. The instrument of claim 13 wherein the interface system is further adapted to communicate content displayable within the display format on the mobile device.

15. The instrument of claim 11 wherein the interface system is adapted to compress data transmittable to the mobile device.

16. The instrument of claim 11 wherein the interface system is adapted to encrypt data transmittable to the mobile device.

17. The instrument of claim 11 wherein the interface system is adapted to transmit an identifying set of data to the mobile device such that the identifying set of data identifies the electronic test instrument to the mobile device.

18. The instrument of claim 17 wherein the identifying set of data is includable within a data transmission from the interface system.

19. A mobile device for controlling an electronic test instrument comprising;
a wireless interface adapted to connect to the electronic test instrument;
a controller connected to the wireless interface, the controller adapted to control the electronic test instrument; and
a user interface connected to the controller, the user interface including a plurality of controls adapted to remotely operate the electronic test instrument.

20. The device of claim 19 wherein the user interface includes a graphical user interface.

21. The device of claim 19 wherein the user interface includes configurable command modes, the configurable command modes configurable in response to an identity of the electronic test instrument.

22. The device of claim 21 wherein the configurable command controls are automatically configured by the electronic test instrument.

23. The device of claim 19 wherein the user interface includes a touch screen user interface.

24. The device of claim 19 wherein the mobile device is adapted to select between two or more electronic test instruments.

25. The device of claim 24 wherein the mobile device is adapted to communicate with two or more electronic test instruments substantially simultaneously.

26. A method of testing a system under test comprising:
disposing a mobile device proximally to the system under test;
connecting an electronic test instrument to the system under test;
connecting the mobile device to the electronic test instrument; and
commanding the mobile device to control the electronic test instrument such that the electronic test instrument tests the system under test.

27. The method of claim 26 further comprising the step of displaying a set of controls for the electronic test instrument on the mobile device.

28. The method of claim 27 wherein the set of controls includes a representation of the set of controls for the electronic test instrument.

29. The method of claim 27 wherein the set of controls includes a representation of the system under test.

30. The method of claim 27 wherein the set of controls includes a representation of a menu of available operations.

31. The method of claim 26 further comprising the step of displaying a representation of the state of the system under test.

32. The method of claim 26 further comprising the step of displaying a representation of the set of controls for the electronic test instrument and a representation of the system under test.

33. A method of providing a user interface to a system under test comprising:
providing an electronic test instrument adapted to test the system under test;
providing a mobile device adapted to connect to the electronic test instrument; and
interfacing the mobile device with the electronic test instrument such that mobile device includes a user interface adapted to control the electronic test instrument.

34. The method of claim 33 wherein the mobile device is portable.

35. The method of claim 33 wherein the user interface includes configurable command modes, the configurable command modes configurable in response to an identity of the electronic test instrument.

36. The method of claim 35 wherein the configurable command controls are automatically configured by the electronic test instrument.

37. The method of claim 33 wherein the user interface includes a touch screen user interface.

38. The method of claim 33 wherein the mobile device is adapted to select between two or more electronic test instruments.

39. The method of claim 38 wherein the mobile device is adapted to communicate with two or more electronic test instruments substantially simultaneously.

40. The method of claim 33 further comprising the step of connecting the electronic test instrument to the system under test.

41. The method of claim 40 further comprising the step of collecting data from the system under test.

42. The method of claim 40 further comprising the step of transmitting the data collected by the electronic test instrument from the electronic test instrument to the mobile device.

43. The method of claim 42 further comprising the step of compressing the data collected by the electronic test instrument.

44. The method of claim 42 further comprising the step of encrypting the data collected by the electronic test instrument.

45. The method of claim 33 wherein the electronic test instrument is adapted to define the user interface.
